(19) United States
(12) Patent Application Publication
(10) Pub. No.: US 2003/0072060 A1
(43) Pub. Date: Apr. 17, 2003

(54) Optical communication apparatus and system

(76) Inventor: Sason Sourani, Hod Hasharon (IL)

Correspondence Address: NATH & ASSOCIATES, Sixth Floor, 1030 Fifteenth Street, N.W., Washington, DC, 20005, US

(21) Appl. No.: 10/266,580

(22) Filed: Oct. 9, 2002

(30) Foreign Application Priority Data
Oct. 11, 2001 (IL) 145859

(51) Int. Cl. H04B 10/00; H04B 10/06

(52) U.S. Cl. 359/172; 359/191; 359/192

(57) ABSTRACT

A method and apparatus for transmitting and receiving optical signals. The apparatus comprises at least one CW laser, at least one optical transmitter and at least one polarization independent heterodyne optical receiver. A first portion of the output of the CW laser is used for providing a local oscillator light source for the heterodyne receiver and a second portion of the output of the CW laser is used as a light source for the transmitter.

### FIELD OF THE INVENTION

The present invention relates to an optical access system network for delivering various services to the subscriber premises using optical fibers.

### BACKGROUND OF THE INVENTION

In the recent years, network service providers have made huge investments to develop a modern network infrastructure capable of carrying massive loads of broadband signals. These investments were made mainly in core networks and in metropolitan (metro) networks. Broadband networks are being extended to the access networks, towards the customer premises. In order to accommodate the high bandwidth requirements, the modern access networks are based on signals' transmission via optical fibers. However optical fiber network are regarded as too expensive to be commercially viable for the mass deployment in the access segment of the network where each single subscriber has to be provided with its own broadband connectivity. Therefore there is a need to develop new technologies and methods, which enable broadband access networks at a significantly lower cost.

In U.S. Pat. No. 5,221,983 to Wagner a fiber optic access network architecture is described. This network architecture is based on double star fiber network and two banks of N optical sources for providing each of the N subscribers two optical channels, each channel using a different optical wavelength. One channel is modulated at the central office location with the downstream information to be transmitted towards the subscriber, while the other channel arrives to the subscriber in an unmodulated form. This second channel is modulated at the subscriber premises with the upstream information thus carrying information from the customer premises to the central office of the network service provider.

This method of sending unmodulated channels from the central office location to the subscribers' locations for subsequent upstream transmission might not be practical. The upstream channels are attenuated along the downstream path and once again along the upstream path. Therefore this solution might require very powerful lasers at the central office and optical amplifiers in each remote location. The cost of such a solution might be very high and not suitable for a massive deployment in access networks.

Another communication method for optical access networks was developed by the FSAN consortium. By this method, which is described in the ITU Standard G.983, a PON—Passive Optical Network is used to connect the Central Office or the Point of Presence of the Network Service Provider to the subscriber premises. The bit rate may be 155 Mb/s in both the upstream and downstream directions, or may be 155 Mb/s in the upstream direction and 622 Mb/s in the downstream direction, and is shared by up to 32 subscribers connected to this network. This method indeed reduces the cost of the access network per each subscriber but the bit rate/bandwidth that is provided to each subscriber is relatively very low and might not be sufficient for the increasing demand for broadband services.

Another attractive optical communication method is based on coherent optical transmission while using heterodyne optical receivers. Heterodyne receivers are known for many years in electronics and in optics, (see J. M. P. Delavaux, L. D. Tzeng, M. Dixon and R. E. Tench, “1.4 Gbit/s optical DPSK heterodyne transmission system experiment”, Fourteenth European Conf. On Opt. Commun., (ECOC'88), UK, pp. 475-477, September 1988). Several heterodyne optical detection schemes are described in the literature (see S. Ryu “Coherent Lightwave Communication Systems” 1995, Artech House, section 2.4). One example of implementation of coherent optical communication for broadband access networks is CRHD-Counterreceiving Heterodyne Detection as described in L.Wang et al. “Counterreceiving heterodyne detection with an Integrated Coherent Transceiver and Its Applications in Bandwidth-On-Demand Access Networks”, Journal of Lightwave Technology, vol.17 no.10 October 1999 pp 1724-1731). This technology is based on transmission of signals from a central office location to a plurality of remote nodes via a pair of fibers; one fiber used for the downstream direction whereas the other for the upstream direction. The central terminal is transmitting and receiving a plurality of fixed wavelengths to and from several remote nodes. Each remote node comprises a tunable coherent transceiver that is able to receive one of the fixed wavelengths and to transmit back towards the central office on an adjacent wavelength. The transmission between the central terminal and each remote node was implemented in half duplex, which means that at any given time, each remote node is either transmitting optical signal to the central terminal or receiving an optical signal therefrom. The bandwidth of each wavelength is shared between many subscribers that are connected to that remote node on a “bandwidth-on-demand” basis. The number of the fixed wavelengths is dependent on the demand for bandwidth of the subscribers. Again, the bandwidth dedicated to each subscriber is limited by two factors: the half-duplex transmission that reduces the bandwidth by at least 50% and the sharing of bandwidth of each wavelength among many subscribers. However, one of the major drawbacks of the solution described in this reference and would prevent its implementation in commercial systems is the lack of polarization matching between the received signal and the local oscillator. The problems associated with such lack of polarization matching and several solutions to these problems were described in details by S. Ryu in Chapter 6 of “Coherent Lightwave Communication Systems” 1995, Artech House. Unfortunately, none of the solutions proposed in the art to solve the problems associated with polarization matching, is applicable for the CRHD technology.

The disclosure of these references as well as the disclosure of the references mentioned throughout the present specification are hereby incorporated by reference.

Therefore, there is a need to develop technologies and methods that will enable cost effective sharing of fiber optic infrastructure among several subscribers but without limiting the bandwidth that is delivered to each subscriber.

### SUMMARY OF THE INVENTION

It is therefore an object of the present invention to provide a novel communication apparatus and system for use in an optical communication network.

It is another object of the present invention to provide a method for communication in a network comprising a central unit and one or more remote units.

Other objects of the present invention will become apparent as the description of the present invention proceeds.

According to one embodiment of the present invention there is provided a communication apparatus adapted for transmitting and receiving optical signals and comprising at least one CW laser, at least one optical transmitter and at least one polarization independent, heterodyne optical receiver, wherein a first portion of the output of said at least one CW laser is used for providing a local oscillator light source for said at least one heterodyne optical receiver and wherein a second portion of the output of said at least one CW laser is used as a light source for said at least one optical transmitter. As will be appreciated by those skilled in the art, the term “polarization independent heterodyne optical receiver” as used herein is used to denote a heterodyne optical receiver that is adapted to receive optical signals irrespective of their polarization state.

According to an embodiment of the invention, the communication apparatus further comprises:

control means adapted to allow polarization matching of the polarization state of the optical signals received (or substantially identical signals, e.g. amplified signals etc.) by said communication apparatus with the first portion of the at least one CW laser output; and

at least one coupling means adapted to combine the optical signals which are at substantially the same polarization state.

According to another embodiment of the invention, the communication apparatus further comprises at least two optical detectors adapted to achieve polarization diversity between the optical signals received by said communication apparatus and the light emitted from said local oscillator light source.

More preferably, this communication apparatus further comprising at least one polarization beam splitter adapted to split the optical signals received (or substantially identical optical signals thereto) into substantially orthogonally polarized optical signals.

By yet another embodiment of the invention, the difference between the operating frequency of the at least one optical transmitter and the operating frequency of the at least one heterodyne optical receiver is less than 50 GHz.

In accordance with another embodiment of the invention, the communication apparatus is adapted for transmitting optical signals from a first location to at least a second location and which is further adapted for receiving optical signals at said first location from said at least a second location. More preferably, the transmission of optical signals from the first location to the at least a second location is carried over at least one optical channel selected from a first plurality of optical channels. In addition or in the alternative, the optical signals received from the at least a second location are carried over at least one optical channel selected from a second plurality of optical channels.

By still another embodiment of the present invention, the optical signals transmitted from the first location and the optical signals received at the at least one location are carried along a single optical fiber.

By yet another embodiment of the invention, frequency difference between each two adjacent optical channels among the first plurality of optical channels is equal or less than 100 GHz.

In accordance with yet another embodiment, the optical channels included in the first plurality of optical channels, are all located within a range of less than 350 GHz.

In accordance with still another embodiment of the invention, the communication apparatus is further adapted to transmit signals by the at least one optical transmitter simultaneously while receiving signals at the at least one heterodyne optical receiver.

According to another aspect of the invention, there is provided a communication system adapted for transmitting signals between at least a first apparatus located at at least a first location and a at least a second apparatus located at at least a second location over an optical network, wherein each of the first apparatus is adapted for transmitting and receiving optical signals and each of the first apparatus comprises at least one CW laser, at least one optical transmitter and at least one polarization independent, heterodyne optical receiver, which apparatus is characterized in that a first portion of the output of the at least one CW laser of the at least first apparatus is used for providing local oscillator light source for the at least one heterodyne optical receiver of the first apparatus and wherein a second portion of the output of the at least one CW laser is used as a light source for the at least one optical transmitter of the first apparatus.

In accordance with a preferred embodiment of this aspect of the invention, the first apparatus is adapted to transmit signals by its at least one optical transmitter to each of the at least one second apparatus, simultaneously with receiving signals at its at least one heterodyne optical receiver transmitted from the second apparatus.

According to another embodiment, the optical signals transmitted by the first apparatus, are transmitted along an optical fiber through which the optical signals are received by the first apparatus.

Preferably, the at least one first apparatus comprises a central unit located at the first location and the at least one second apparatus comprises a remote unit located at the second location.

In accordance with still another embodiment of the invention, the at least one first apparatus comprises a central unit located at the first location and the at least one second apparatus comprises a plurality of remote units, and at least two of these remote units are located at different locations.

By yet another embodiment, the transmission of optical signals from the at least first apparatus to the at least second apparatus is carried over at least one optical channel selected from a first plurality of optical channels, and the optical signals transmitted by the at least second apparatus are carried over at least one optical channel selected from a second plurality of optical channels. Preferably, the frequency difference between each two adjacent optical channels among the first plurality of optical channels is equal or less than 100 GHz. Optionally or in the alternative, all optical channels included in the first plurality of optical channels, are located within a range of less than 350 GHz.

In accordance with still another embodiment of the invention, the frequency difference between signals transmitted by the first apparatus and signals transmitted from the second apparatus and received at the first apparatus is substantially the same as the frequency difference between signals transmitted by the second apparatus and signals transmitted from the first apparatus and received at the second apparatus.

According to still another aspect of the invention there is provided a method for operating an optical communication link extending between a first unit located at a first location and at least one second unit located at at least one second location, wherein said first unit comprises at least one CW laser, at least one optical transmitter and at least one polarization independent, heterodyne optical receiver, which method comprises:

a. allocating a portion of the output of the at least one CW laser of the first unit for providing local oscillations for the at least one heterodyne optical receiver of the first unit; and

b. allocating another portion of the output of said at least one CW laser of the first unit for use as a light source for the at least one optical transmitter of the first unit.

Preferably, this method further comprising the step of:

c. transmitting optical signals by the at least one optical transmitter of said first unit simultaneously while receiving optical signals at the at least one heterodyne optical receiver of said first unit.

By yet another embodiment, the method further comprising a step of:

transmitting optical signals from said at least a second unit towards said first unit over an optical channel which is located at a frequency of less then 50 GHz different than the frequency at which the optical signals are transmitted from said first unit towards the at least one second unit.

According to another embodiment, the method further comprises the step of:

detecting at the at least one second unit an idle optical channel among a plurality of optical channels and selecting that channel for receiving information transmitted from the first unit.

According to yet another embodiment, the method further comprising the step of:

transmitting acknowledgement information from the first unit to the at least one second unit.

More preferably, the acknowledgement information comprises information identifying the at least one second unit.

### BRIEF DESCRIPTION OF THE DRAWINGS

Particular non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 shows a simplified illustration of an optical access network implementing the present invention;

FIG. 2 illustrates schematically the relevant parts of an OSLAM and OAD in carrying out communications in accordance with the present invention;

FIG. 3A shows schematically a typical heterodyne receiver provided with polarization diversity;

FIG. 3B shows schematically another embodiment of a typical heterodyne receiver provided with polarization diversity;

FIG. 4 presents a typical spectrum at the input of an IF amplifier;

FIG. 5 describes an example of implementing the present invention in a point to multi-point type of communication;

FIG. 6 describes the signals' spectrum received at the input of a heterodyne receiver;

FIG. 7 demonstrates a prior art embodiment wherein the transmissions at both directions are combined together by an optical combiner/splitter and are conveyed over a single fiber; and

FIG. 8 demonstrates an embodiment of the invention wherein the transmissions at both directions are combined together by an optical combiner/splitter and are conveyed over a single fiber.

### DETAILED DESCRIPTION OF THE INVENTION

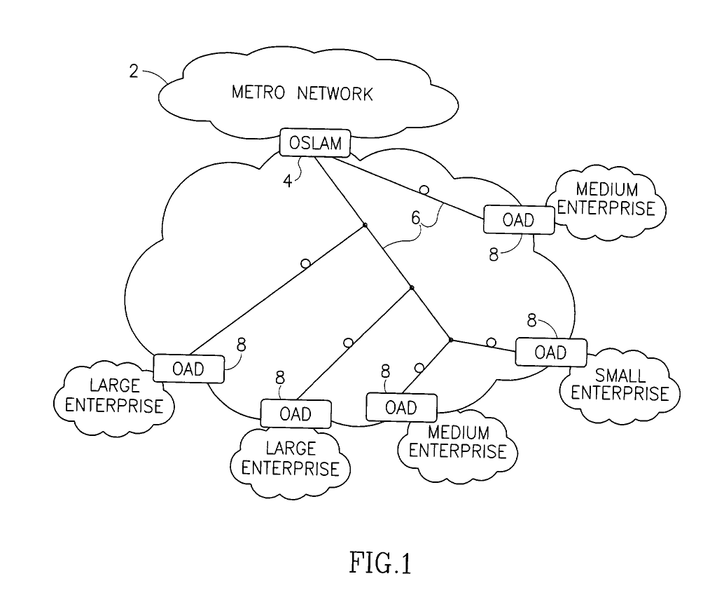

FIG. 1 shows a simplified illustration of an optical access network. Typically such an optical access network allows connectivity between a metropolitan (metro) network and the customers' premises. A metro network 2, which is typically based on fiber optics infrastructure, using standard transmission methods such as SONET or Ethernet, is connected to an Optical Subscriber Line Access Multiplexer (referred to hereinafter as “OSLAM”) 4. In the downstream direction, OSLAM 4 is operative to receive the traffic destined to many subscribers, from metro network 2 and to transmit it over a plurality of optical channels via a fiber optic cable 6 to various Optical Access Devices (referred to hereinafter as “OADs”) 8 located at the subscribers premises.

Each downstream optical channel is capable of carrying traffic to a corresponding OAD 8. The various OADs 8 are operative to selectively receive downstream optical channel/s over optical fiber intended for the corresponding subscriber. In the other direction, the upstream direction, the traffic from each subscriber is transmitted from the corresponding OAD 8, via the fiber optic cable 6 to OSLAM 4, wherein each of OADs 8 is operative to transmit on a dedicated, upstream optical channel or optical channels. In OSLAM 4, the traffic received from all OADs 8 is aggregated and conveyed to metro network 2. In this manner the broadband traffic from metro network 2 is connected cost-effectively to many subscribers via a single fiber optic cable 6. It should be appreciated that the fiber optic cable 6 as shown in this example can be constructed in many network topologies such as: bus (shown here), ring, or mesh. It should be also appreciated that although in this example, a single fiber optic cable 6 is carrying the traffic in both directions: from the metro network 2 to the subscribers and also from the subscribers to the metro network 2, still the present invention should be understood to encompass the case were the downstream and upstream transmissions are conveyed over different optical fibers.

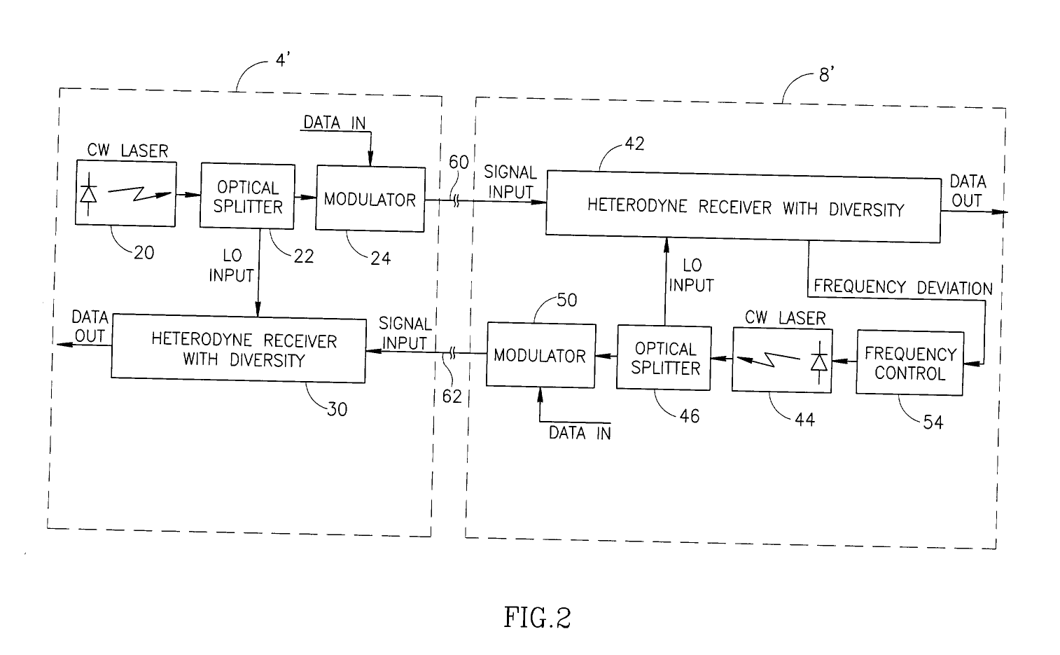

FIG. 2 describes the relevant parts of OSLAM 4, device 4′ and device 8′ of one OAD 8, the combination of which allows communication between OSLAM 4 and OAD 8. This communication is based on coherent optical transmission and coherent heterodyne optical reception technology that is different from the “Classical WDM” approach that was proposed in U.S. Pat. No. 5,221,983 to Wagner et al. As will be shown below, the coherent heterodyne optical reception technology has several advantages over the Classical WDM, among which:

1. Receiver sensitivity is substantially better than WDM,

2. It enables dynamic allocation without using costly components (tunable filters etc.)

3. It may be used with a single bi-directional fiber.

One important feature of an optical heterodyne receiver is the requirement for polarization matching between the received optical signal and the local oscillator. In order to achieve proper heterodyne reception of an optical signal, a good matching between the State Of Polarization (“SOP”) of the local oscillator and the SOP of the received signal is required. However, in practice, the received signal's SOP fluctuates as a result of various phenomena occurring in the fiber transmission medium. These fluctuations might severely impact the sensitivity of the heterodyne receiver. Therefore the heterodyne receiver should be polarization-independent, which means that it should be able to properly receive any input optical signal regardless of its SOP at any given time instant. There are several schemes described in the literature to solve such a problem. The two most practical schemes are: polarization control and polarization diversity. In the polarization control scheme an active polarization control device is inserted in series with the received signal. This device is controlled to achieve a match between the polarization of the received signal and the local oscillator signal. In the polarization diversity scheme, the received signal light is typically split into two orthogonally polarized lightwaves by a polarizing beam splitter. Each of the two orthogonally polarized optical signals is combined with the local oscillator optical signal in two separate optical couplers and then each of the combined optical signals is detected by a different detector. In this manner the heterodyne detection is done by two coherent detectors, so that for any incoming polarization of the received signal, at least one detector detects a signal that results from a proper polarization matching between the received signal and the local oscillator signal. The outputs of the two receivers are then combined to generate a detected signal that is polarization independent. The specific implementation of this scheme is described for example in the following description of the embodiment of the invention. As will be shown below, unlike the CRHD technology described above, the present invention includes a heterodyne optical receiver that is polarization independent, so that its performance is not degraded during polarization fluctuations of the received optical signals.

In addition, coherent heterodyne optical reception technology may use low cost, narrow bandwidth laser source for the local oscillator while the same laser may be used as the optical transmitter.

Narrow bandwidth laser sources of several MHz are of common use in WDM today. Usually these laser sources can be trimmed to the desired wavelength using temperature control or any other technology (Liquid Crystal, MEMS, etc.) over a frequency range of several hundreds of GHz.

FIG. 2 demonstrates means for communication between the OSLAM shown in FIG. 1 and one of the OADs is also shown in that FIG. 1.

Blocks 20, 22, 24, and 30 comprise part of the OSLAM (designated as OSLAM 4′) which is operative to communicate with blocks 42, 44, 46, 50 and 54 that comprise part of OAD (and designated as OAD 8′) over two unidirectional fibers 60 and 62.

In this example, OSLAM 4′ transmits signals towards OAD 8′ using a narrow band laser (e.g. bandwidth of several MHz). The wavelength of the laser will be typically stabilized at a desired wavelength using temperature control, but it should be appreciated that any other wavelength control technology may be used. Laser 20, which is a continuous wave (“CW”) laser, is connected to modulator 24 via optical splitter 22. Modulator 24 is operative to modulate the data that is destined to OAD 8′ and it output is conveyed along fiber 60 towards OAD 8′.

At OAD 8′, the modulated optical signal received from OSLAM 4′ is inputted to heterodyne receiver 42. A CW laser 44, which is similar to CW laser 20 in OSLAM 4′, is also connected to a heterodyne receiver 42 via an optical splitter 46 operating as a local oscillator (LO). The frequency difference between laser 44 and laser 20 is controlled and maintained at a predetermined value “IF” (Intermediate Frequency). Usually the IF frequency will be several times the bit rate transmitted. Typically, when the transmission bit rate is 1 Gb/s, the IF is about 4 GHz.

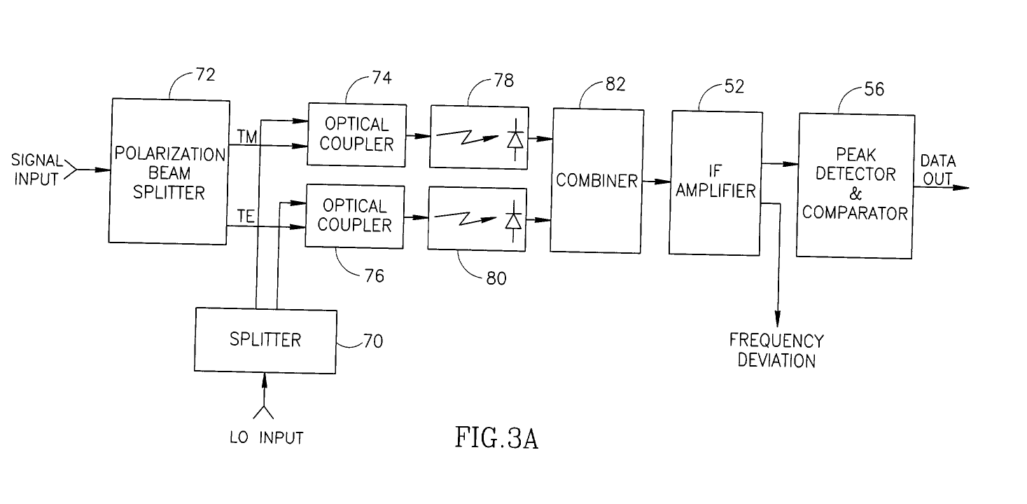

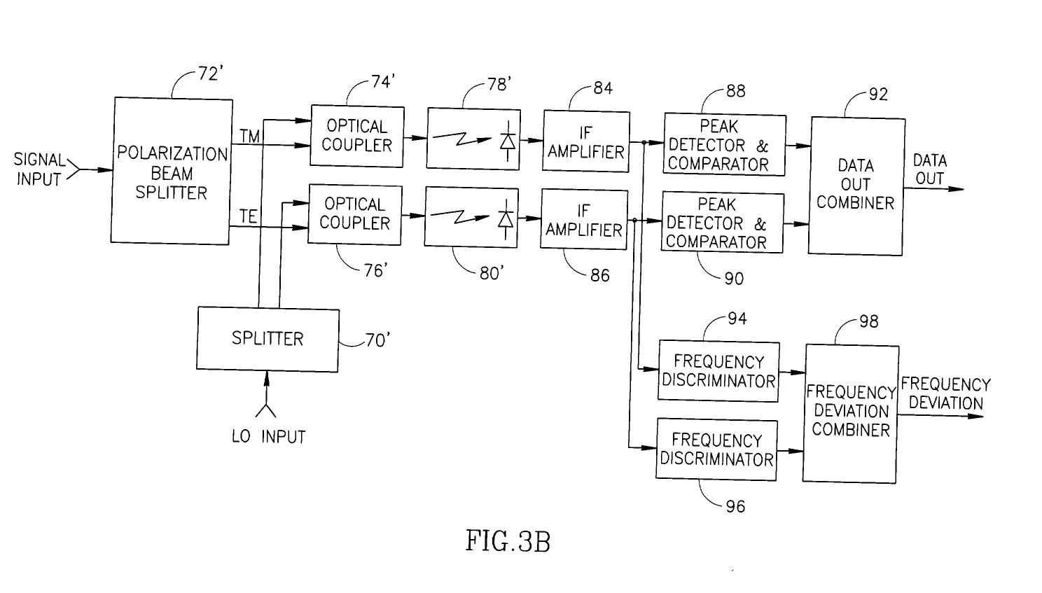

In order to ensure the proper interaction between local oscillator 44 and received signals via fiber 60, the polarization state of the two signals should be, at least partially, matched. In order to prevent performance degradations during polarization fluctuations of the received signals, the heterodyne receiver 42 includes polarization diversity means, which will be further described in conjunction with FIG. 3 below.

Heterodyne receiver 42 as shown in FIG. 2, is operative to convert the optical signals to electronic signals, to selectively amplify the desired signals around the IF frequency and to detect the digital incoming data from the IF signal. Heterodyne receiver 42 is also operative to stabilize the difference between the desired, received optical frequency and the local oscillator optical frequency at the IF frequency. The heterodyne receiver 42 generates a frequency deviation signal, which is input to frequency control 54. Frequency control 54, is in turn connected to the input of the wavelength control of a local oscillator/CW laser 44, and is operative to set the wavelength of the local oscillator/CW laser 44 at the desired value and to perform fine tuning of the wavelength according to the frequency deviation signal. It should be noted that the stabilization of local oscillator/CW laser 44 automatically ensures that the frequency difference between the desired received signal and the output of CW laser 20, which is also used as local oscillator in OSLAM 4′, in a manner similar to that explained above. Therefore laser 20 in OSLAM 4′ does not need to be absolutely stabilized since local oscillator 44 in OAD 8′ will lock on and continue to track CW laser 20 with a frequency difference equal to the IF frequency.

It should be noted that the IF signal is not a continuous signal but an intermitted one according to the “1”'s and “0”'s transmitted by OSLAM 4′. However, even though the signal is not continuous, it is possible to close the desired loop of local oscillator 44 e.g. by averaging the IF signal. A more detailed description of the operation of heterodyne receiver 42 is provided below in conjunction with FIG. 3.

As shown in FIG. 2, CW Laser/local oscillator 44 is also used in the transmission of the signals from OAD 8′. In order to achieve that, block 46 is operative to split the energy of CW laser 44 so that part of this energy is used as the LO input while the other part of the energy is used for transmission to OSLAM 4′ as described above. The input to external modulator 50 is fed via splitter 46 by laser 44 where this external modulator 50 is operative to modulate the signals transmitted from OAD 8′ to OSLAM 4′ over fiber 62. The output of external optical modulator 50 is conveyed along fiber 62 to OSLAM 4′ carrying the signals from OAD 8′ to OSLAM 4′. These optical signals are then inputted to heterodyne receiver 30. As already described, OAD 8′ is capable of adjusting the difference between the two CW lasers 20 and 44, and set it to be equal to the IF frequency. A signal at IF frequency at the OSLAM 4′ is generated by heterodyne receiver 30 utilizing part of the optical signal of the laser 20 provided to the LO input of heterodyne receiver 30, via optical splitter 22. The output of the heterodyne receiver 30 is the signals received by OSLAM 4′ from OAD 8′. Preferably, there is no need for a feedback loop in the OSLAM 4′ since the received signal in OSLAM 4′ is automatically set by the OAD 8′ at the IF difference from the CW laser/local oscillator 20.

FIG. 3A describes a typical heterodyne receiver provided with polarization diversity. This type of heterodyne receiver is preferably used in heterodyne receivers 30 and 42, in either OAD 8′ or OSLAM 4′, described above. Since the polarization state of the incoming signal is unknown and might vary quite randomly with time, polarization diversity is used wherein two orthogonally polarized parts of the incoming optical signal are used in such heterodyne receiver. The optical input signal is splitted by a polarization beam splitter 72 into two optical signals, wherein one output of polarization beam splitter 72 has a polarization state which is orthogonal to the other output (e.g. TE and TM). One output of the polarization beam splitter 72 is conveyed to optical coupler 76 while the other output is conveyed to optical coupler 74. The LO optical signal is conveyed via splitter 70 to two optical couplers 74 and 76. The output of optical coupler 74 is connected to optical detector 78 while the output of optical coupler 76 is connected to optical detector 80. Each of the optical detectors 78 and 80 is operative to convert the optical field signal, at its input, to electronic signal that is proportional to the square of said optical field signal. The electrical signals thus received from optical detectors 78 and 80 are then summed in combiner 82. The optical input signal, irrespective of its polarization state is splitted by polarization beam splitter 72, so that at least one of the optical detectors 78 and 80 generates an active output signal. Therefore this solution is independent of the polarization state of the optical input signal to the heterodyne receiver. As will be described below, the output of each of optical detectors 78 and 80 comprises various signals, while one of them is the difference signal between the desired input signal and the LO signal. The output of combiner 82 is typically connected to an IF filter/amplifier 52 that is operative to select the desired difference signal at the IF frequency.

It should be noted that other optical signals co-transmitted along fiber 60 having optical frequencies of at least several times greater than the IF frequency, will either be averaged by the optical detectors 78 and 80 or will be blocked by IF amplifier 52. This important feature enables selective reception of a desired signal in a point to multi-point network, which will be described below. The output of IF amplifier 52 is also conveyed to a peak detector and comparator 56 to allow the extraction of the data received by OAD 8′ from OSLAM 4′ or by OSLAM 4′ from OAD 8′, accordingly. IF amplifier 52 is also operative to generate a frequency deviation signal which is used by frequency control 54 to fine tune CW laser 44, as described below. In OSLAM 4′ the frequency deviation signal is not used, since the closed loop tuning of the CW laser is performed only in the OAD 8′.

FIG. 3B describes another embodiment of heterodyne receiver provided with polarization diversity. This type of heterodyne receiver is preferably used in heterodyne receivers 30 and 42, in either OAD 8′ or OSLAM 4′, described above, mutates mutandis. Since the polarization state of the incoming signal is unknown and might vary quite randomly with time, polarization diversity is used wherein two orthogonally polarized parts of the optical input signal are used in such heterodyne receiver. The optical input signal is splitted by a polarization beam splitter 72′ into two optical signals, wherein one output of polarization beam splitter 72′ has a polarization state which is orthogonal to the other output (e.g. TE and TM). One output of the polarization beam splitter 72′ is conveyed to optical coupler 76′ while the other output is conveyed to optical coupler 74′. The LO optical signal is conveyed via splitter 70′ to two optical couplers 74′ and 76′. The output of optical coupler 74′ is connected to optical detector 78′ while the output of optical coupler 76′ is connected to optical detector 80′. Each of the optical detectors 78′ and 80′ is operative to convert the optical field signal, at its input, to electronic signal that is proportional to the square of said optical field signal. The output of each of the optical detectors 78′ and 80′ is connected via corresponding IF amplifiers 84 and 86 to corresponding peak-detectors/comparators 88 and 90, respectively. For any polarization state of the optical input signal, introduced at the input to polarization beam splitter 72′, at least one of the optical detectors 78′ and 80′ will generate an active output signal. Therefore this solution is independent of the polarization state of the input signal to the heterodyne receiver. As will be described below, the output of each of optical detectors 78′ and 80′ comprises various signals, while one of them is the difference signal between the desired input signal and the LO signal.

It should be also noted that other optical signals co-transmitted along fiber 60 having optical frequencies of at least several times greater than the IF frequency, will either be averaged by the optical detectors 78′ and 80′ or will be blocked by IF amplifiers 84 and 86. This important feature enables selective reception of a desired signal in a point to multi-point network, which will be described below.

The outputs of peak-detectors/comparators 88 and 90 is combined in data out combiner 92 to produce a data out signal. As opposed to the heterodyne receiver described in conjunction with the embodiment shown in FIG. 3A, in the case of the heterodyne receiver described in conjunction with the embodiment shown in FIG. 3B, the signal detected in the two orthogonal polarizations is combined at the data output stage rather than at the IF signal stage. The output of each of the IF amplifiers 84 and 86 is also fed into corresponding frequency discriminators 94 and 96. The outputs of frequency discriminators 94 and 96 is combined by frequency deviation combiner 98 to produce a frequency deviation signal which is used by frequency control 54 to fine tune CW laser 44, as described above. In OSLAM 4′ the frequency deviation signal is not used, since the closed loop tuning of the CW laser is performed only in the OAD Following is an analysis of the signals in a heterodyne receiver. The following analysis refers for example to heterodyne receiver 42 as described in conjunction with FIG. 3A. It should be understood that a similar analysis applies to heterodyne receiver 30 and for the alternative embodiment of both heterodyne receivers 42 and 30 as described in conjunction with FIG. 3B. The following analysis assumes, for the sake of simplicity of the description, that the input signal has the same polarization as the LO signal and only one optical coupler 74 and one optical detector 78 are used in the heterodyne receiver 42. However, the preferred embodiment of the invention should use polarization diversity or other polarization matching means as described above.

Let us now assume that during the transmission of “1”, the transmitter at the OSLAM 4 has an amplitude of Aₐₜ, frequency of fₐ and at the input of heterodyne receiver 42 a phase φₐ. Let us also assume that the attenuation of fiber 60 from the OSLAM 4 to the OAD 8 is k_{ab}. At the input of heterodyne receiver 42 we would get:

sₐ(t)Aₐₜk_{ab} cos(2πfₐt+φₐ)

where sₐ(t) is the signal information transmitted by OSLAM 4 (Usually it will be an NRZ type of signal of “0” and “1”, where each bit has a duration of Tₐ).

Let us now assume that local oscillator 44 at the input of heterodyne receiver 42 has the following signal:

A_{br} cos(2πf_{b}t+φ_{b})

where A_{br} is the amplitude of the signal received at the input of optical coupler 74 and φ_{b} is the phase at that point.

As explained above, we assume that the polarization states of both signals are similar. In such case the optical detector 78 of heterodyne receiver 42 will average the power of the sum of the two signals. ‘Averaging’ in this case, is relative to the speed performance of the optical detector 78. Let us assume that the optical detector 78 is capable of detecting signals with frequency of f_{if} (which is the frequency of the IF) with negligible attenuation but is not capable of detecting signals at frequencies substantially higher than f_{if}.

The current received out of optical detector 78 will be the average of:

[sₐ(t)Aₐₜk_{ab} cos(2πfₐt+φₐ)+A_{br} cos(2πf_{b}t+φ_{b})]²

Assuming sₐ(t) has a fixed value of “1”, all the terms appearing in the above formula are either “0 frequency” or at the “optical frequency” (i.e. frequency that is typically at the order of hundreds of THz) except for the cross multiplication which yields both the sum (the “optical frequency”) and the difference (IF frequency).

Consequently, only the IF frequency will pass the IF amplifier 52 and will be detected by the peak detector and comparator 56 shown in FIG. 2.

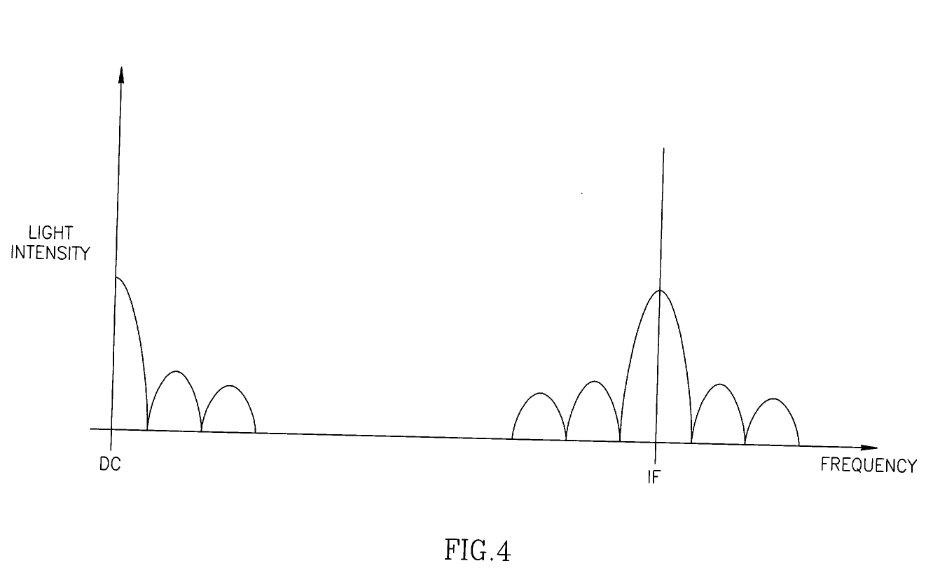

If sₐ(t) has a bit duration of Tₐ, and 1/Tₐ is much smaller than the bandwidth of the IF amplifier 52, the IF signal will be spread, having a spectrum reminding a sync function as can be seen in FIG. 4 (to be exact, a sync function will be created if a continuous stream of “0101010 . . . ” is transmitted, for a random pattern of information the spectrum of the signal will be slightly different).

As can be seen from FIG. 4, at the “0 frequency” there is also a ‘sin X/X’ spectrum. This spectrum is due to the “0 frequency” component generated during the squaring operation of sₐ(t)Aₐₜk_{ab} cos(2πfₐₜ+φₐ). Part of this energy is transformed into pulsed DC (‘pulsed’—due to sₐ(t)). A similar calculation may be carried out for OSLAM 4′.

It should be noted that for CW lasers 20 and 44 standard, low cost WDM lasers, such as DFB lasers, may be used, since they may easily be adjusted within the desired practical range, by thermal control means at a rate of 10 GHz/° C. Therefore a tuning range of 200-300 GHz is easily achievable.

The technology described above can be used also for multi-point operation where each point may receive a different channel (or a different group of channels). In our case, as described in FIG. 1, one OSLAM 4 is communicating with several OADs 8. Therefore OSLAM 4 is operative to communicate with each of OADs 8 over a different wavelength and each of OADs 8 is operative to communicate back to the OSLAM 4 on a wavelength which is adjacent to the wavelength at which the transmission was received from OSLAM 4, while the difference between each upstream frequency and downstream frequency is IF as described above. Like in the well-known WDM operation this method may be used for long reach, medium reach or short reach operation.

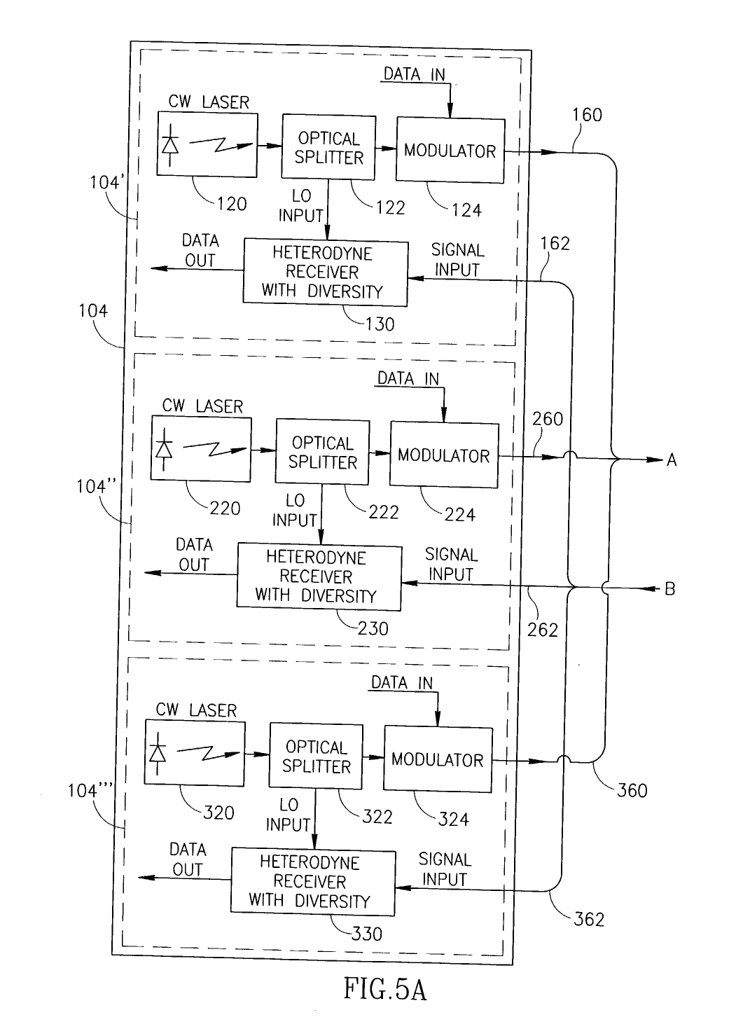

FIG. 5 describes an example of implementing the present invention in a point to multi-point communication between one OSLAM 104 and 3 OADs 108, 208 and 308, by using 3 pairs of transceivers. In this example, OSLAM 104 is operative similarly mutatis mutanis to the way described in connection with OSLAM 4 of FIGS. 1 and 2. Similarly, OADs 108, 208 and 308 are operative similarly to the way OADs 8 of FIGS. 1 and 2 are operative. As may be seen in this example, OSLAM 104 comprises a number of transceivers 104′, 104″ and 104′″, each of which is designated to communicate with its corresponding OAD transceivers 108, 208 and 308, respectively. The OSLAM and OAD transceivers of each of the three pairs i.e. 104′ and 108, 104″ and 208 and 104′″ and 308, are capable of exchanging full duplex information in the same manner as described above for the point to point communication example, illustrated in FIG. 2. Transceiver 104′ comprises blocks 120, 122, 124 and 130 and is operative to communicate with the transceiver 108′ which comprises blocks 142, 144, 146 and 150. Similarly, transceiver 104″ comprises blocks 220, 222, 224 and 230 is operative to communicate with transceiver 208 which comprises blocks 240, 242, 244 and 250. Transceiver 104′″ comprises blocks 320, 322, 324 and 330 is operative to communicate with the transceiver 308 that comprises blocks 340, 342, 344 and 350. Three pairs of fibers 160 and 162, 260 and 262, and 360 and 362 are connected in a similar manner to fibers' pair 60 and 62 as shown in FIG. 2. The operation of all heterodyne receivers 130, 142, 230, 242, 330 and 342 is similar to the one described in connection with FIG. 3.

It is not always possible or cost effective to use multiple pairs of fibers. Since OSLAM 104 is operative to control lasers 120, 220 and 320 transmitting at different wavelengths that are typically spaced apart from each other by at least 3 times the IF frequency, it is possible to couple the optical signals of fibers 160, 260, and 360 and transmit them along one fiber. Similarly it is possible to couple the optical signals of fibers 162, 262 and 362 and transmit them along another fiber. In this manner it is possible to use only one pair of fibers for most of the path extending between OSLAM 104 and OADs 108, 208 and 308, and split this pair of fibers into separate fibers only on the last portion of the path extending from OSLAM 104 to the corresponding OADs.

Let us discuss the signal received at OAD 108 while using the same terms used in the description of FIG. 2:

Aₐₜ—Transmission amplitude, OSLAM 104 at the output modulator 124

A_{ct}—Transmission amplitude, OSLAM 104 at the output modulator 224

Aₑₜ—Transmission amplitude, OSLAM 104 at the output modulator 324

k_{ad}—Attenuation OSLAM 104 to OAD 108

k_{cd}—Attenuation OSLAM 104 to OAD 208

k_{ed}—Attenuation OSLAM 104 to OAD 308

fₐ,φₐ—Optical transmission frequency and phase of OSLAM 104 at the output modulator 124

f_{c},φ_{c}—Optical transmission frequency and phase of OSLAM 104 at the output modulator 224

fₑ,φₑ—Optical transmission frequency and phase of OSLAM 104 at the output modulator 324

sₐ(t)—Signal information transmitted by modulator 124 (Usually it will be an NRZ signal of “0” and “1”, each bit has a duration of Tₐ).

s_{c}(t)—Signal information transmitted by modulator 224 (Usually it will be an NRZ signal of “0” and “1”, each bit has a duration of T_{c}).

sₑ(t)—Signal information transmitted by modulator 324 (Usually it will be an NRZ signal of “0” and “1”, each bit has a duration of Tₑ).

Let us now calculate the signal over the shared fiber as it arrives to heterodyne receiver 142 located in OAD 108. The outputs of the three transmitters are summed and attenuated. Assuming different attenuation per each source we get:

sₐ(t)k_{ad}Aₐₜ cos(2πfₐₜ+φₐ)+s_{c}(t)k_{cd}A_{ct} cos(2πf_{c}t+φ_{c})+sₑ(t)k_{ed}Aₑₜ cos(2πfₑt+φₑ)

Adding a fraction of the transmitter of OAD 108 energy to the above formula, one would get:

sₐ(t)k_{ad}Aₐₜ cos(2πfₐt+φₐ)+s_{c}(t)k_{cd}A_{ct} cos(2πf_{c}t+φ_{c})+sₑ(t)k_{ed}Aₑₜ cos(2πfₑt+φₑ)+A_{dr} cos(2πf_{d}t+φ_{d})

A_{dr} is the fraction of energy looped from the laser 144 of OAD 108 to the receiver. f_{d} and φ_{d} are the frequency and phase of the signal respectively. As we use a heterodyne receiver with polarization diversity, we assume again that A_{dr} has the same polarization state as all other signals and thus the field intensities are vector-added (as a matter of fact the only relevant polarization state is the polarization state of the signal to be detected). In our case OAD 108 should listen to the signal arriving from modulator 124 of OSLAM 104 and only the polarization state of that signal is relevant).

As in the previous example, described in FIG. 2, the heterodyne receiver 142 output current will be proportional to the low-pass portion of the energy of the above signal.

Let us now assume that the difference in frequency between fₐ, f_{c}, fₑ is very large relative to the IF frequency which is the frequency difference between f_{c} and f_{d}.

The result of squaring the last equation gives two types of multiplications:

1. Multiplication of the same signal by itself

2. Multiplication of any combination of two different signals

The first type of multiplication results in “0 frequency” component and a component with twice the optical frequency. Heterodyne receiver 142 regards both components as “0 frequency”.

The second type of multiplication results the sum and the difference of the two products. The sum has approximately twice the optical frequency and will be regarded as “0 frequency”. The interesting part is the difference.

Since we assume that the difference between any two transmitters is much higher than the IF frequency, the signal will not pass the IF filter. As a matter of fact it may not pass even the detector in heterodyne receiver 142 due to the high frequency difference between the two signals.

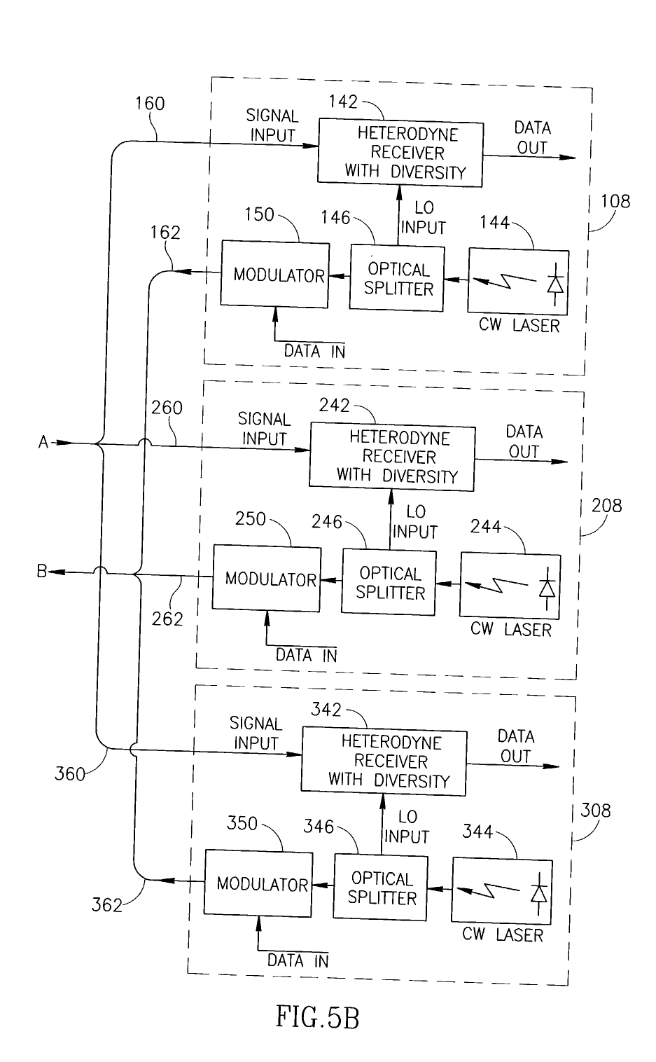

FIG. 6 describes the signals' intensities received at the signal input of heterodyne receiver 142 on the frequency scale. The signals arriving from modulators 124, 224 and 324, which are marked as “A”, “C” and “E”, respectively, may have different amplitudes. In addition they carry information so that each of them consumes a bandwidth, which is proportional to the bit rate of that information. In this example, heterodyne receiver 142 is operative to receive the signal marked as “C”. Therefore output of CW laser 144, acting as Local Oscillator (marked as “D”) is adjusted to be at a frequency that is higher than the frequency of signal “C” by the IF frequency. As can be seen the wavelength/frequency spacing between any two optical channels is substantially higher than the IF frequency. Signals at the IF frequency will be produced at the output of heterodyne receiver 142 whenever the Local Oscillator is either below or above the desired signal with a frequency difference of IF. In this example, the closest undesired frequency to the desired IF signal will be signal “E” minus the Local Oscillator frequency. In order to prevent overlap and ambiguity between channels, the spacing between the optical channels should preferably be at least, about 3 times the IF frequency. For example, for a transmission of information at a rate of 1.25 Gb/s, a minimal IF frequency should be about 4 GHz. Therefore a minimal channel spacing of about 12.5 GHz is required. In this case 16 channels in one fiber can be accommodated using lasers that are thermally tunable in the range of 200-300 GHz. In a case where only 4 channels are required and having the same type of lasers, a channel spacing of 50 GHz may be used. In this case the IF frequency will be about 15 GHz and the transmitted bit rate will be up to 5 Gb/s. In a case where only 2 channels are required and having the same type of lasers, a channel spacing of 100 GHz may be used. In this case the IF frequency will be about 35 GHz and the transmitted bit rate will be up to 10 Gb/s. It should be noted that the IF frequency is also the frequency difference between the downstream and the upstream optical channels. Therefore in this embodiment of the invention the practical maximum of the frequency difference between the downstream and the upstream channels is 15 GHz and the maximal channel spacing is 50 GHz.

The local oscillator of OAD 108 is a CW signal with a narrow bandwidth according to the performance of the laser. Usually it will have much larger energy in order to receive higher IF signal (the IF signal is proportional to the amplitude of the local oscillator). The limit to the local oscillator value will be the quantization effect due to shot noise at the detector (see D. W. Smith “Techniques for Multigigabit Coherent Optical Transmission”, J. Lightwave Technol., LT-5, p.1466, 1987. The paper relates to a homodyne receiver but the basics are true for heterodyne technology as well).

The spectrum at the output of heterodyne receiver 142 will be very similar to the previous example (FIG. 2). Higher frequency components will be either regarded as “0 frequency” by the heterodyne receiver 142 (which is limited in bandwidth) or attenuated considerably by the heterodyne receiver 142. In any case, even if the heterodyne receiver 142 were capable of operating in those high frequencies, the signals will be blocked by the IF filter.

Another element of the invention is related to the possibility of using the same fiber for bi-directional transmissions. Namely, using one fiber instead of fibers 60 and 62 of FIG. 2 and using one fiber instead of fiber 160, 162 260, 262, 360 and 362 of FIG. 5.

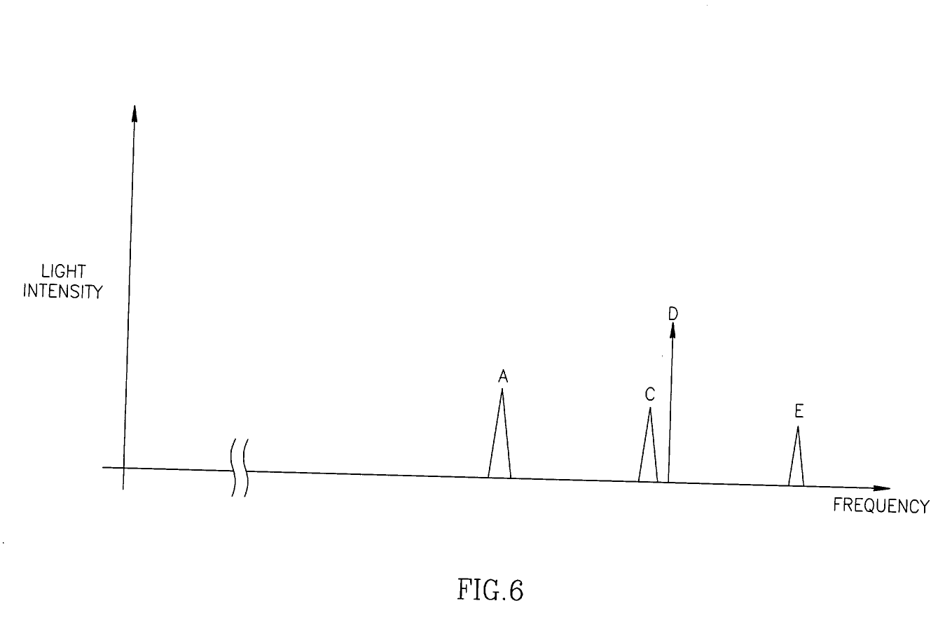

We shall first examine the case of a prior art optical transmission. In the scheme shown in FIG. 7 the transmissions in both directions are combined together by an optical combiner/splitter 424. The laser 420 is externally modulated by modulator 422. Theoretically, combiner 424 will not reflect the laser transmission to the optical detector 430 since the light has its momentum vector and the direction of the transmission is from left to right. Nevertheless the components are not ideal and reflections do occur.

If we assume that the reflection of the connector 426 is in the range of −30 db, the signal received by the optical detector 430 will be:

sₐ(t)r_{ad}Aₐₜ cos(2πfₐt+φₐ)

where:

sₐ(t)—The NRZ information data at the input to modulator 422

r_{ad}—Reflection coefficient

Aₐₜ—Transmitter amplitude, of laser 420

fₐ,φₐ—Frequency and phase of the optical signal

On the other hand, optical detector 430 will receive the desired information transmitted from another terminal:

s_{b}(t)k_{bd}A_{bt} cos(2πf_{b}t+φ_{b})

where:

s_{b}(t)—The NRZ information data of another terminal arriving to optical detector 430

k_{bd}—Link attenuation between two terminals

A_{bt}—Transmitter amplitude of the other terminal

f_{b},φ_{b}—Frequency and phase of the optical signal

Assuming Aₐₜ and A_{bt} are of similar magnitudes and the received signal is of the same order of magnitude as the reflections, it will be impossible to distinguish between the reflection resulting from the local transmission and the desired received signal. A possible solution for this ambiguity will be the use of an optical filter and to use different optical frequencies for each transmission.

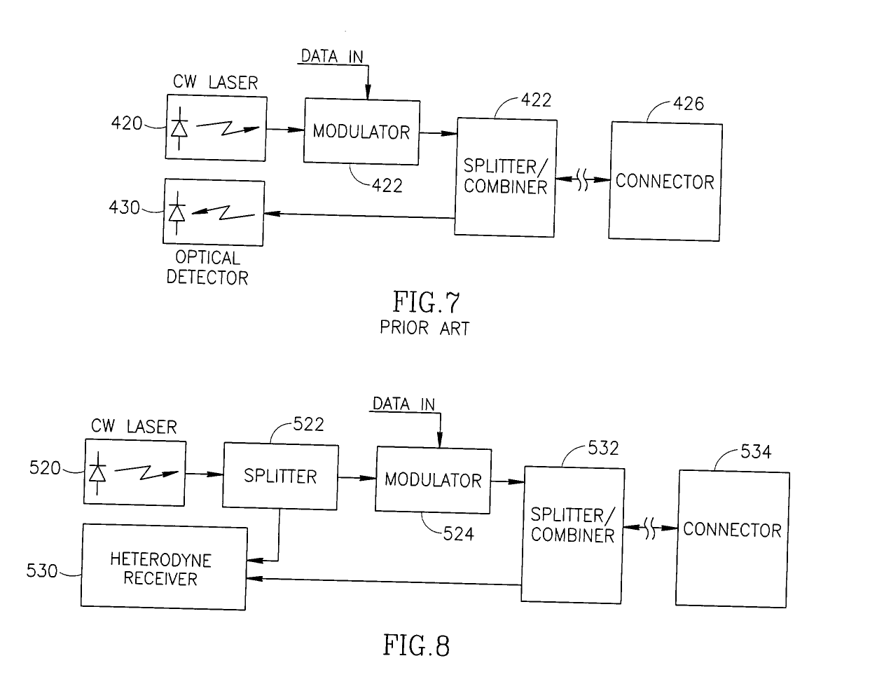

The situation of heterodyne transmission is presented in FIG. 8. The energy of the CW laser/local oscillator 520 will be:

Aₐᵣ cos(2πfₐt+φₐ)

where Aₐᵣ is the fraction of the local oscillator 520 amplitude that is connected via splitter 522 to the input of heterodyne receiver 530 and added to the received signal which arrives from another terminal. This energy has constant (CW) energy without any NRZ keyed information.

On the other hand, as in the previous example, NRZ keyed information that is transmitted from modulator 524 is reflected back from many non-ideal components such as the connector 534. Unlike the energy that is arriving to the heterodyne receiver 530 from the CW-laser/local-oscillator, the reflected energy will be NRZ keyed with sₐ(t)—the information at the data input of modulator 524. Therefore the reflected energy will be:

sₐ(t)r_{ad}Aₐₜ cos(2πfₐt+φₐ)

In that last formula we used φ′ₐ rather than φₐ. This indicates that φₐ is different than φ′ₐ.

The two signals, the local oscillator 520 signal and the reflected signal are summed together and contribute to the IF signal. The IF signal will be formed by the cross multiplication of both signals with the received signal from another terminal. In this example we ignore the polarization of the signals. We assume same polarization of both signals. This is the worst case.

s_{b}(t)k_{bd}A_{bt} cos(2πf_{b}t+φ_{b})[Aₐᵣ cos(2πfₐt+φₐ+sₐ(t)r_{ad}Aₐₜ cos(2πfₐt+φ′_{a]}

sₐ(t) will interfere with s_{b}(t) but the amount of interference will be the ratio between r_{ad}Aₐₜ and Aₐᵣ. If we use relatively large energy at the local oscillator Aₐᵣ, say in the range of Aₐₜ the result of the interference will be very small, the amount of r_{ad}. If r_{ad} reflects small quantity of energy, it will have a negligible effect on the receiver.

As has been proved, the immunity of the heterodyne technology to reflections in the case of a single bi-directional fiber is much higher than the immunity of standard NRZ transmission. This is true for the use of heterodyne technology in Point to Point topology as well as in Point to Multi Point and Multi Point to Multi Point topology.

One of the most important advantages of the technology described above is its ability to dynamically tune each element in the network to a desired optical channel. Unlike WDM where the optical frequency of each channel should be considerably different, here, the difference between each channel may be very small. For example, as described above, 12.5 GHz spacing between optical channels may be enough for 1 Gb/s transmission.

Changing the optical frequency of a laser in the range of several multiples of 12.5 GHz may be easily accomplished with conventional WDM lasers, such as DFB lasers. Hence, the same laser may cover easily over 12-16 channels, which is a tuning range of 200-300 Ghz.

In this case, all transmitting/receiving apparatus may be similar, yet they are tuned to different channels.

According to another aspect of the present invention there is provided a method of tuning an OAD to the desired optical channel. FIG. 6 illustrates, on a frequency scale, an example of 3 channels transmitted over one fiber. As explained above, one of these three channels should be used as the media for conveying signals to that OAD and the question remains how to establish which of these channels could be used by that OAD. A preferred method of determining which is the proper channel available for communication comprises the following three main steps:

a. Establishing local maximum of energy in the IF amplifier 52, 84 and 86, in order to allow locking on points of maximum energy.

Several techniques for locking to the local maximum energy are known in the art per se. ‘Dithering’ is one of such techniques. By this technique, small fluctuations in the frequency axis are applied and the corresponding changes in the light intensity axis are detected. At the OAD, the peaks of energy are detected by analyzing the gradient of the light intensity during the fluctuations in frequency. Once these peaks are found, a locking technique allows compensating for any drifts occurring in the transmitter or in the local oscillator. Another technique for verifying that the received signal is located at the center of the IF amplifiers 52, 84 and 86 is to use a frequency discriminator such as frequency discriminators 94 and 96 to generate a frequency deviation indication of the received signal from the center of the IF filter.

b. The next step comprises scanning the frequency range in order to avoid detection of imaginary channels. This technique may use control logic that sweeps the frequency range of the optical channels and locks sequentially onto all relevant peaks. As explained above, a heterodyne receiver produces a double active IF signal: when the frequency of the LO is lower than that of the desired signal and when the frequency of the LO is higher than that of the desired signal. Therefore during the frequency scanning, a heterodyne receiver will generate, at the IF output two energy peaks for each optical channel: one when the LO is lower than the optical channel by the IF frequency and another when the LO is higher than the optical channel by the IF frequency. If we define that the first one is an imaginary peak, then the control logic will allow skipping every second peak (imaginary peaks).

c. The third step is the selection of the desired channel. The control logic decodes the information transmitted from an OSLAM (e.g. the channel ID). If the outcome of this operation is that the channel is an idle one, or in other words this channel is available for communication, it will stay on the current peak. If the result is that this optical channel is not idle, the control logic will continue sweeping and will lock onto the next peak. The information may be embedded in the transmission information (as an example—MAC address in Ethernet protocol, etc.) or, alternatively, the information may modulate in low frequency the data signal.

Once an available optical channel is selected, the OAD may initiate a transmission on an adjacent channel (e.g. where the two channels are 15 GHz or less, apart) towards the OSLAM indicating that the idle channel selected, is the one that will be used during the coming communication session. The use of shared fiber requires splitting of the signals transmitted to the remote units which results in a decrease of the energy received by each channel. As has been mentioned, according to prior art, heterodyne operation is superior in performance relative to standard Intensity Modulation Direct Detection (IM/DD) figures of 10-25 db are quoted in T. Okoshi, K. Emura, K. K. Kikuchi and R. Th. Kersten, J. Opt. Commun., 2, p. 89, 1981. This may easily compensate the loss of energy in the various optical splitters and in the fiber between the OSLAM 4 and any OAD 8. Other shared fiber technologies may suffer from lack of adequate energy unless they use more powerful (and more costly) laser modules.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments describe the best mode contemplated by the inventors and therefore include structure, acts or details of structures and acts that may not be essential to the invention and which are described as examples. Structure and acts described herein are replaceable by equivalents, which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A communication apparatus adapted for transmitting and receiving optical signals and comprising at least one CW laser, at least one optical transmitter and at least one heterodyne optical receiver, wherein a first portion of the output of said at least one CW laser is used for providing a local oscillator light source for said at least one heterodyne optical receiver and wherein a second portion of the output of said at least one CW laser is used as a light source for said at least one optical transmitter, and wherein said heterodyne optical receiver is adapted to receive optical signals irrespective of their polarization state.

2. A communication apparatus according to claim 1, wherein said apparatus further comprising:
control means adapted to allow polarization matching of said optical signals essentially as received by said communication apparatus with said first portion of the at least one CW laser output; and
at least one coupling means adapted to combine the optical signals which are at substantially the same polarization state.

3. A communication apparatus according to claim 1, further comprising at least two optical detectors adapted to achieve polarization diversity between the optical signals received by said communication apparatus and the light emitted from said local oscillator light source.

4. A communication apparatus according to claim 3, further comprising at least one polarization beam splitter adapted to split into substantially orthogonally polarized optical signals said optical signals received or substantially identical optical signals thereto.

5. A communication apparatus according to claim 1, wherein the difference between the operating frequency of said at least one optical transmitter and the operating frequency of said at least one heterodyne optical receiver is less than 50 GHz.

6. A communication apparatus according to claim 1, adapted for transmitting optical signals from a first location to at least a second location and which is further adapted for receiving optical signals at said first location from said at least a second location.

7. A communication apparatus according to claim 6, wherein the transmission of optical signals from said first location to said at least a second location is carried over at least one optical channel selected from a first plurality of optical channels.

8. A communication apparatus according to claim 7, wherein the optical signals received from said at least a second location are carried over at least one optical channel selected from a second plurality of optical channels.

9. A communication apparatus according to claim 6, wherein said optical signals transmitted from said first location and said optical signals received at said at least one location are carried along a single optical fiber.

10. A communication apparatus according to claim 6, wherein the frequency difference between each two adjacent optical channels among said first plurality of optical channels is equal or less than 100 GHz.

11. A communication apparatus according to claim 6, wherein the optical channels included in said first plurality of optical channels, are located within a range of less than 350 GHz.

12. A communication apparatus according to claim 1, wherein said communication apparatus is further adapted to transmit signals by said at least one optical transmitter simultaneously while receiving signals at said at least one heterodyne optical receiver.

13. A communication system adapted for transmitting signals between at least a first apparatus located at at least a first location and a at least a second apparatus located at at least a second location over an optical network, wherein each of said first apparatus is adapted for transmitting and receiving optical signals and each of said first apparatus comprises at least one CW laser, at least one optical transmitter and at least one polarization independent, heterodyne optical receiver, which apparatus is characterized in that a first portion of the output of said at least one CW laser of the at least first apparatus is used for providing local oscillator light source for said at least one heterodyne optical receiver of said first apparatus and wherein a second portion of the output of the at least one CW laser is used as a light source for said at least one optical transmitter of said first apparatus.

14. A communication system according to claim 13, wherein said first apparatus is adapted to transmit signals by its at least one optical transmitter to each of the at least one second apparatus simultaneously while receiving signals at its at least one heterodyne optical receiver transmitted from said second apparatus.

15. A communication system according to claim 13, wherein the optical signals transmitted by said first apparatus, are transmitted along an optical fiber through which the optical signals are received by said first apparatus.

16. A communication system according to claim 13, wherein said at least one first apparatus comprises a central unit located at said first location and wherein said at least one second apparatus comprises a remote unit located at said second location.

17. A communication system according to claim 13, wherein said at least one first apparatus comprises a central unit located at said first location and wherein said at least one second apparatus comprises a plurality of remote units, wherein at least some of said plurality of remote units are located at different locations.

18. A communication system according to claim 13, wherein the transmission of optical signals from said at least first apparatus to said at least second apparatus is carried over at least one optical channel selected from a first plurality of optical channels, and wherein the optical signals transmitted by said at least second apparatus are carried over at least one optical channel selected from a second plurality of optical channels.

19. A communication system according to claim 18, wherein the frequency difference between each two adjacent optical channels among said first plurality of optical channels is equal or less than 100 GHz.

20. A communication system according to claim 18, wherein all optical channels included in said first plurality of optical channels, are located within a range of less than 350 GHz.

21. A communication system according to claim 18, wherein the frequency difference existing between signals transmitted by said first apparatus and signals transmitted from said second apparatus and received at said first apparatus is substantially the same as the frequency difference between signals transmitted by said second apparatus and signals transmitted from said first apparatus and received at said second apparatus.

22. A method for operating an optical communication link extending between a first unit located at a first location and at least one second unit located at at least one second location, wherein said first unit comprises at least one CW laser, at least one optical transmitter and at least one polarization independent, heterodyne optical receiver, which method comprises:
a. allocating a portion of the output of said at least one CW laser of said first unit for providing local oscillations for said at least one heterodyne optical receiver of said first unit; and
b. allocating another portion of the output of said at least one CW laser of said first unit for use as a light source for said at least one optical transmitter of the first unit.

23. A method according to claim 22, further comprising a step of:
transmitting optical signals from said at least a second unit towards said first unit over an optical channel which is located at a frequency of less then 50 GHz different than the frequency at which the optical signals are transmitted from said first unit towards said at least second unit.

24. A method according to claim 22, further comprising a step of:
detecting at said at least a second unit an idle optical channel among a plurality of optical channels and selecting said channel for receiving information transmitted from said first unit.

25. A method according to claim 22, further comprising the step:
transmitting acknowledgement information from said first unit to said at least second unit.

26. A method according to claim 25, wherein the acknowledgement information, comprises information identifying said at least second unit.

27. A method according to claim 22, further comprising:
transmitting optical signals by said at least one optical transmitter of said first unit simultaneously while receiving optical signals at said at least one heterodyne optical receiver of said first unit.
